(19) United States
(12) Patent Application Publication
(10) Pub. No.: US 2015/0207381 A1
(43) Pub. Date: Jul. 23, 2015

(54) DEVICE HAVING AT LEAST ONE PANCAKE MOTOR ROTOR, AND ASSEMBLY METHOD

(71) Applicants: Helmut Hauck, Euerbach (DE); Hubert Herbst, Gadheim (DE); Thomas Herterich, Poppenhausen (DE); Christian Kaiser, Uchtelhausen (DE)

(72) Inventors: Helmut Hauck, Euerbach (DE); Hubert Herbst, Gadheim (DE); Thomas Herterich, Poppenhausen (DE); Christian Kaiser, Uchtelhausen (DE)

(21) Appl. No.: 14/399,997

(22) PCT Filed: May 8, 2013
(86) PCT No.: PCT/EP2013/059619

§ 371 Date: Nov. 10, 2014

(30) Foreign Application Priority Data
May 9, 2012 (DE) 10 2012 207 758.8

(51) Int. Cl. H02K 7/08; H02K 15/02; H02K 1/27

(52) U.S. Cl. CPC H02K 7/08; H02K 1/2793; H02K 15/02

(57) ABSTRACT

A device includes at least one stator and at least one flat motor rotor having at least one magnet unit configured to magnetically interact with the stator such that a drive force for rotating the flat motor rotor relative to the stator acts on the magnet unit. The device further includes at least one first bearing which contributes to rotatably supporting the flat motor rotor relative to the stator, and a second bearing which contributes to rotatably supporting the flat motor rotor relative to the stator. At least part of the first bearing abuts on one side of the flat motor rotor, and at least part of the second bearing abuts on the other side of the flat motor rotor, and the two bearings are preloaded against each other.

The invention emanates from a device according to the preamble of claim 1.

A device including a stator and a rotor is known from the publication DE 10 2007 013 732 B4. Permanent magnets in the rotor are accelerated by energized stator windings.

The object of the invention consists, in particular, of providing a device of the above-mentioned type which has a high efficiency. The object is inventively achieved by the features of claim 1, while advantageous designs and further developments of the invention can be derived from the dependent claims.

The invention emanates from a device including at least one stator, at least one flat motor rotor, which includes at least one magnet unit, which is provided to magnetically interact with the stator such that at least one drive force for rotating the flat motor rotor relative to the stator acts on the magnet unit, and including at least one first bearing which at least contributes to a rotatable supporting of the flat motor rotor relative to the stator.

It is proposed that at least a part of the bearing abuts on the flat motor rotor. “Provided” should be understood in particular to mean specially equipped and/or specially designed. A “flat motor rotor” should be understood in particular to mean a rotor which is provided for use as rotor of a flat motor. A “magnet unit” should be understood in particular to mean a unit which is comprised of one or more elements on which forces are exertable with the help of magnetic fields, wherein the unit can include in particular at least one permanent magnet and/or in particular at least one coil. The bearing includes a bearing inner ring and a bearing outer ring, wherein the bearing outer ring of the bearing abuts on the flat motor rotor, and the bearing inner ring on the stator.

Due to this arrangement the bearing or the rolling-element bearing can be supported only on the stator and on the rotor, i.e. a direct arrangement or supporting of the bearing inner ring on the shaft can be omitted. In this way the supporting can also be effected especially far outward radially, which leads to a particularly low-tolerance supporting of the motor. In particular, the supporting of the rotor relative to the stator can be effected at any position which is particularly sensitive to tolerances, namely at the air gap in the vicinity of the magnets or the magnet unit. A supporting at this position can avoid the occurrence of lever arms, which could increase still further the intrinsic tolerance of the supporting bearing. This also makes it possible, for example, to choose the air gap narrower. A low tolerance leads in turn to a uniform power development of the motor and to a uniform torque. In particular, due to the connection of the outer ring of the bearing to the rotating rotor, the rotating part of the assembly, which is vulnerable to wobbling movements, can be supported very far outward radially. It also makes possible to use with high precision the specific arrangement of standardized radial bearings or rolling-element bearings for a supporting of the rotor of a flat motor, which can result in, among other things, an increased flexibility and low costs.

In other words, the system of bearing inner ring and bearing outer ring directly on the rotor and stator leads to a direct supporting of both elements with respect to each other, i.e.

the effective gap is decoupled very well from many further tolerances or sources of error, which can originate, for example, from the motor shaft, which leads to a minimized and constant effective gap under rotation. Possible electrical power losses are minimized due to the efficiency of the motor being optimized. With an abutting bearing preload, the connection of the outer ring of the bearing to the rotating rotor and of the inner ring to the fixed stator leads to an O-arrangement, which is generally accompanied by a maximum support length, equivalent to a maximum system rigidity. This can also further improve the effective gap and thus the power of the motor.

A high efficiency can be achieved using an inventive design. In particular, a high efficiency of a flat motor which includes the device can be achieved. In particular, movements and oscillations of the flat motor rotor and of parts of the flat motor rotor can largely be prevented in an axial direction of the bearing relative to the stator despite high motor rotational speed, fluctuating and/or high temperature, vibrations, impact loads, and rotor deformations, whereby a driving of the flat motor rotor with high efficiency is achieved. In particular, a long service life of the device can be achieved.

It is further proposed that a quotient which is formed by the division of a maximum distance which an outer ring of the first bearing has from an axis of rotation of the flat motor rotor by an average distance which the magnet unit has from the axis of rotation is greater than 0.4. A “maximum distance” which an outer ring of the first bearing has from an axis of rotation of the flat motor rotor shall in particular be understood to mean the maximum distance of a plurality of distances which is formed by the distances of all conceivable partial regions of the outer ring from the axis of rotation. An “axis of rotation” of the flat motor rotor shall in particular be understood to mean an axis about which the flat motor rotor rotates during operations. An “average distance which the magnet unit has from the axis of rotation” shall in particular be understood to mean

$$\frac{1}{V} \int r d V ,$$

wherein the integral is to be taken over the volume of the magnet unit, V is the total volume of the magnet unit, and r is the positive distance of the respective volume element dV from the axis of rotation. In this way a particularly secure axial fixing of the flat motor rotor can be achieved.

The quotient is preferably greater than 0.6. In this way a secure axial fixing of the flat motor rotor can be achieved, particularly in a region of the magnet unit, whereby a high efficiency is achieved.

It is also proposed that the device includes a second bearing which contributes to rotatably supporting the flat motor rotor relative to the stator and which abuts on a side of the flat motor rotor which faces the side of the flat motor rotor on which the first bearing is disposed. In this way an extensive fixing of an axial position of the flat motor rotor can be achieved.

It is furthermore proposed that the stator, the flat motor rotor, and the two bearings are disposed in an X-arrangement or O-arrangement relative to one another. In this way a reliable power transmission can be achieved with a constructively simple design.

It applies advantageously to the first bearing that the quotient formed by the outer diameter of the first bearing divided by the maximum axial bearing width of the first bearing is greater than or equal to 6. In this way an axially short and nevertheless stable design is achieved.

Furthermore an assembly method is proposed, in particular for manufacturing the device, wherein a shim is fitted onto a stator element of a stator, a first bearing is fitted onto the shim, and a flat motor rotor is fitted onto the first bearing. In this way a high efficiency is achieved. In particular, a simple assembly is achieved.

Further advantages will become apparent from the following description of the drawing. An exemplary embodiment of the invention is depicted in the drawing. The drawing, the description, and the claims contain numerous features in combination. The person skilled in the art will also advantageously consider the features individually and combine them into further meaningful combinations.

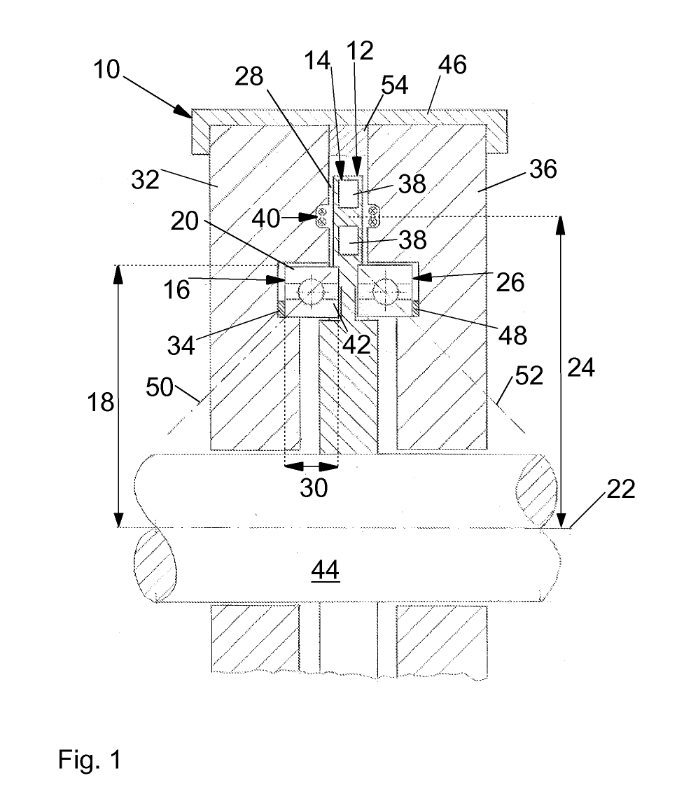

FIG. 1 shows a partial section through an inventive device.

FIG. 1 shows a partial section through an inventive device which includes a stator 10, a flat motor rotor 12, a shaft 44, and a first and a second bearing 16, 26. The flat motor rotor 12 includes a magnet unit 14 which is formed from a plurality of permanent magnets 38 which are distributed uniformly around a circle whose midpoint falls on the axis of rotation 22 of the flat motor rotor 12. The device is part of a flat motor wherein during an operation thereof, the flat motor rotor 12 and the axis of rotation 22 rotate relative to the stator 10. The stator 10 comprises a first and a second stator element 32, 36 and includes stator windings 40 which are disposed on the stator elements 32, 36 opposite the magnet unit 14. During operation of the device, current flows through the stator windings 40 so that a magnetic field is generated which exerts forces on the magnet unit 14 which cause the flat motor rotor 12 to rotate about the axis of rotation 22 relative to the stator. The shaft 44 is attached to the flat motor rotor 12.

The bearings 16, 26 are formed identically and as rolling-element bearings. Furthermore, the bearings 16, 26 contribute to the rotatable supporting of the flat motor rotor 12 relative to the stator. The bearing 16 includes an outer ring 20 and an inner ring 42. The outer ring 20 abuts on a first side of the flat motor rotor 12. In addition, an outer ring of the second bearing 26 abuts on a second side of the flat motor rotor 12, which second side faces the first side. The bearing inner ring 20 abuts on the stator 10 and is fixed there radially inward, and axially. The bearing inner ring 42 abuts on the rotor 12 and is fixed there radially outward, and axially.

A quotient which is formed by the division of a maximum distance 18 which the outer ring 20 of the first bearing 16 has from the axis of rotation 22, and which is the radial outer radius of the outer ring, by an average distance 24 which the magnet unit 14 has from the axis of rotation 22, is greater than 0.6. The quotient which is formed by the outer diameter of the first bearing 16 divided by the maximum axial bearing width 30 of the first bearing 16 is greater 6.

A bracket 46 of the stator 10 preloads the stator elements 32, 36 against each other. A shim 34 is disposed between the stator element 32 and the inner ring 42 in the axial direction, which shim 34 abuts on the stator element 32 and the inner ring 42. Furthermore, a shim 48 is disposed between the stator element 36 and the inner ring of the bearing 26 in the axial direction, which shim 48 abuts on the stator element 36 and this inner ring. The preload of the stator elements 32, 46 against each other is transferred to the bearings 16, 26 by the shims 34, 48, so that these bearings 16, 26 are preloaded against each other in the axial direction along the axis of rotation 22. A line 50, along which a force is transferred from the stator element 32 to the flat motor rotor, intersects a line 52, along which a force is transferred from the stator element 36 to the flat motor rotor 12, in a point of intersection which has a distance from the axis of rotation 22 which is greater than the distance 18. This corresponds to an O-arrangement. In an alternative embodiment it is conceivable that the point of intersection has a distance from the axis of rotation 22 which is less than the distance 18. This corresponds to an X-arrangement.

The stator element 32 and the flat motor rotor 12 form a gap 28 which has a gap width of under 1 mm. In addition, the stator element 36 and the flat motor rotor 12 form a gap which has a gap width of under 1 mm.

During an assembly of the device, first the shim 34 is fitted onto the stator element 32, then the bearing 16 is fitted onto the shim 34, hereinafter the flat motor rotor 12 is fitted onto the bearing 16, then the bearing 26 is fitted onto the flat motor rotor 12, hereinafter a shim is fitted onto the bearing 26 and furthermore the stator element 36 is fitted onto the shim, wherein a further stator element 54 is inserted between the stator elements 32 and 36. While the flat motor rotor is rotated relative to the stator elements 32, 36, the stator elements 32, 36 are preloaded against each other by the bracket 46, wherein the distance of the stator elements 32, 36 to each other reduces by 30 μm until the stator elements 32, 36 both contact the annular stator element 54. A screw connection can also be used instead of the bracket 46. Prior to the preloading, the approximate gap widths of the gaps between the flat motor rotor and the stator elements 32, 36 are set using the shims, wherein the flat motor rotor is rotated relative to these stator elements.

A part of the flat motor rotor which holds the permanent magnets is formed from carbon. Bores of the inner rings of the bearing can have a diameter of 140 millimeters. Furthermore, the outer rings of the bearing can have an outer diameter of 175 mm.

The bearings are provided with lubricant, and the device includes seals (not shown) which prevent an escaping of the lubricant. The seals can be formed from felt. In addition, the first bearing 16 can have a pitch circle diameter which differs from the pitch circle diameter of the second bearing 26. Furthermore, the first bearing 16 can be formed single- or multi-row. Furthermore, the second bearing 26 can be formed single- or multi-row. The first bearing 16 can in particular be a deep groove ball bearing, angular contact ball bearing, tapered roller bearing, cylindrical roller bearing, or needle roller bearing. The bearing types mentioned can be formed here as axial-, angular-contact-, or radial-bearings. Furthermore, the second bearing 26 can in particular be a deep groove ball bearing, angular contact ball bearing, tapered roller bearing, cylindrical roller bearing, or needle roller bearing. The bearing types mentioned can also be formed here as axial-, angular-contact-, or radial-bearings. In particular, the first and the second bearing can have a different design. Furthermore, the device can include one or more additional bearings (not shown), which abuts or abut via at least one component on the first side and which contributes or contribute to the rotatable supporting of the flat motor rotor 12, wherein this additional bearing or these additional bearings can be formed in particular as deep groove ball bearings, angular contact ball bearings, tapered roller bearings, cylindrical roller bearings, or needle roller bearings, and wherein the additional bearing or the additional bearings can be embodied as axial-, angular-contact-, or radial-bearings. In addition, the device can include one or more further additional bearings (not shown), which abuts or abut via at least one component on the second side and which contributes or contribute to the rotatable supporting of the flat motor rotor 12, wherein this further additional bearing or these further additional bearings can be formed in particular as deep groove ball bearings, angular contact ball bearings, tapered roller bearings, cylindrical roller bearings, or needle roller bearings, and wherein the further additional bearing or the further additional bearings can be embodied as axial-, angular- contact-, or radial-bearings. Furthermore the additional bearing or bearings can be formed single- or multi-row. In addition, the further additional bearing or bearings can be formed single- or multi-row.

The device can in particular be part of a watercraft, of a bus, of a tram, of an aircraft, of an agricultural machine, or of an electric lawnmower.

### REFERENCE NUMBER LIST

10 Stator
12 Flat motor rotor
14 Magnet unit
16 Bearing
18 Distance
20 Outer ring
22 Axis of rotation
24 Distance
26 Bearing
28 Gap
30 Bearing width
32 Stator element
34 Shim
36 Stator element
38 Permanent magnet
40 Stator winding
42 Inner ring
44 Shaft
46 Bracket
48 Shim
50 Line
52 Line
54 Stator element

1. A device including at least one stator, and at least one flat motor rotor having at least one magnet unit configured to magnetically interact with the stator such that at least one drive force for rotating the flat motor rotor relative to the stator acts on the at least one magnet unit, the device further including at least one first bearing which contributes to rotatably supporting the flat motor rotor relative to the stator, and a second bearing which contributes to rotatably supporting the flat motor rotor relative to the stator, wherein, at least a part of the first bearing abuts on a first side of the flat motor rotor, and the second bearing abuts on a second side of the flat motor rotor, and the first and second bearings are preloaded against each other.

2. The device according to claim 1, wherein a quotient of a maximum distance which an outer ring of the first bearing has from an axis of rotation of the flat motor rotor and an average distance which the magnet unit has from the axis of rotation is greater than 0.4.

3. The device according to claim 2, wherein the quotient is greater than 0.6.

4. (canceled)

5. The device according to claim 3, wherein the stator, the flat motor rotor, and the first and second bearings are disposed in an X-arrangement or in an O-arrangement relative to one another.

6. (canceled)

7. The device according to claim 1, wherein the stator and the flat motor rotor form at least one gap which has a gap width which is smaller than 5 mm.

8. The device according to claim 1, wherein the quotient formed by the outer diameter of the first bearing and the maximum axial bearing width of the first bearing is greater than or equal to 6.

9. A machine including a device according to claim 1.

10. (canceled)

11. The device according to claim 1,
wherein a quotient of a maximum distance which an outer ring of the first bearing has from an axis of rotation of the flat motor rotor and an average distance which the magnet unit has from the axis of rotation is greater than 0.6,
wherein the stator, the flat motor rotor, and the first and second bearings are disposed in an X-arrangement or in an O-arrangement relative to one another,
wherein the stator and the flat motor rotor form at least one gap which has a gap width smaller than 5 mm, and
wherein a quotient of the outer diameter of the first bearing and the maximum axial bearing width of the first bearing is greater than or equal to 6.

12. The device according to claim 1, wherein the flat motor rotor is mounted for rotation on a shaft and wherein the first bearing and the second bearing do not contact the shaft.

13. The device according to claim 1, wherein the flat motor rotor is mounted for rotation on a shaft and wherein the first bearing and the second bearing are radially separated from the shaft.

14. A method comprising:
providing a stator having a first stator element and a second stator element;
providing a flat motor rotor having at least one magnet unit configured to magnetically interact with the stator such that a driving force for rotating the flat rotor relative to the stator acts on the at least one magnet unit;
fitting a first shim onto the first stator element;
fitting a first bearing against the first shim;
fitting a second shim onto the second stator element;
fitting a second bearing against the second shim; and
attaching the first bearing and the second bearing to the flat rotor.

15. A device comprising:
at least one stator element;
a flat motor rotor having at least one magnet unit configured to magnetically interact with the stator such that a drive force for rotating the flat motor rotor relative to the stator acts on the at least one magnet unit;
a first bearing having a first portion abutting on a first side of the flat motor rotor and rotatably supporting the flat motor rotor relative to the stator; and
a second bearing having a first portion abutting on a second side of the flat motor rotor and rotatably supporting the flat motor rotor relative to the stator;
wherein the first and second bearings are preloaded by the at least one stator element.

16. The device according to claim 15, wherein the flat motor rotor is mounted for rotation on a shaft and wherein the first bearing and the second bearing do not contact the shaft.

17. The device according to claim 15, wherein the flat motor rotor is mounted for rotation on a shaft and wherein the first bearing and the second bearing are radially separated from the shaft.
